(19) United States
(12) Patent Application Publication
(10) Pub. No.: US 2026/0331472 A1
(43) Pub. Date: Oct. 22, 2026

(54) METHOD FOR REDUCED PARTICLE SIZE AND/OR INCREASED SURFACE AREA ELECTROACTIVE METAL MATERIALS AND ELECTROACTIVE METAL MATERIALS DERIVED THEREFROM

(71) Applicant: Inlyte Energy, Inc., San Leandro, CA (US)

(72) Inventors: Sophie Griggs, San Leandro, CA (US); Brian Wiers, San Leandro, CA (US); Alec Roger Tilley, Ashbourne (GB); Robert Christie Galloway, Derbyshire (GB); William Gent, San Leandro, CA (US)

(73) Assignee: Inlyte Energy, Inc., San Leandro, CA (US)

(21) Appl. No.: 19/654,293

(22) Filed: Apr. 21, 2026

Related U.S. Application Data
(60) Provisional application No. 63/791,867, filed on Apr. 21, 2025.
(60) Provisional application No. 63/906,218, filed on Oct. 27, 2025.

(51) Int. Cl. H01M 4/38; C22B 1/248; H01M 4/02; H01M 4/04; H01M 10/0562

(52) U.S. Cl. CPC H01M 4/38; C22B 1/248; H01M 4/048; H01M 10/0562; H01M 2004/021; H01M 2004/028

(57) ABSTRACT

A method can include: receiving an electroactive metal; comminuting the electroactive metal; optionally comminuting a salt; optionally processing battery components; and optionally assembling a battery. The method preferably functions to process an electroactive metal used for producing active material for metal conversion batteries, molten salt batteries, or sodium metal halide batteries. The battery can include a housing, electrodes (e.g., cathode, anode, etc.) electrolyte (e.g., solid electrolyte, secondary electrolyte, etc.), separator, and/or any suitable materials and/or components. The electrodes can be made from a mixture of particles of a brittle iron alloy and a salt.

### CROSS-REFERENCE TO RELATED APPLICATIONS

This application claims the benefit of U.S. Provisional Application No. 63/791,867, filed 21Apr. 2025, and U.S. Provisional Application No. 63/906,218, filed 27 Oct. 2025, each of which is incorporated in its entirety by this reference.

### TECHNICAL FIELD

This invention relates generally to the metal conversion battery field, and more specifically to a new and useful material and method of preparation in the metal conversion battery field.

### BRIEF DESCRIPTION OF THE FIGURES

FIG. 1 is a schematic representation of an example of the method.

FIG. 2 is a schematic representation of an example for processing battery components.

FIG. 3 is a schematic representation of an example for making a battery mixture.

FIG. 4 are scanning electron micrographs of exemplary ferrous materials before and after comminution.

FIG. 5 is a schematic representation of an example of an oxidation-reduction cycle for processing the electroactive metal.

FIG. 6A and FIG. 6B are plots showing cell potential vs discharge capacity for exemplary iron-salt batteries with different salt processing (e.g., iron-to-salt D50 particle size ratio ~1:8 and iron-to-salt D50 ratio ~1:2.3)

### DETAILED DESCRIPTION

The following description of the embodiments of the invention is not intended to limit the invention to these embodiments, but rather to enable any person skilled in the art to make and use this invention.

### 1. Overview

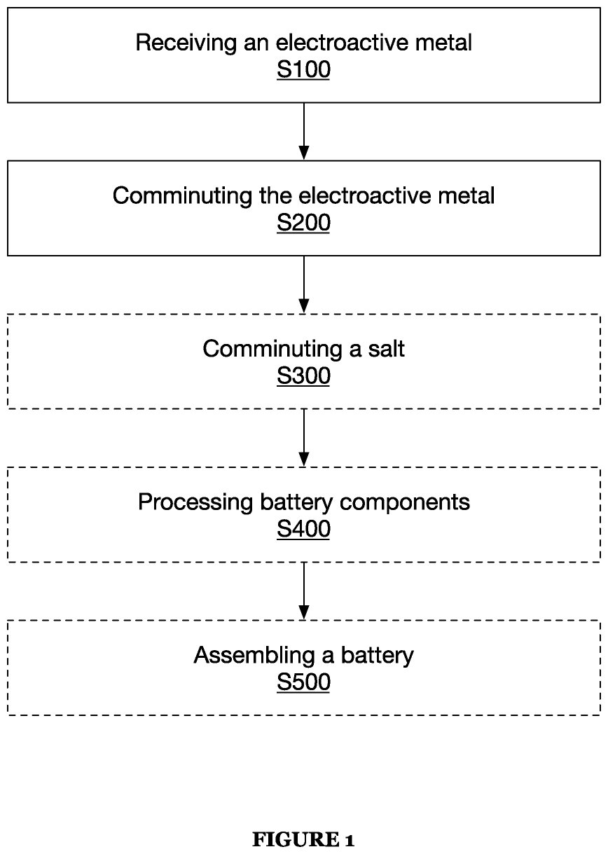

As shown in FIG. 1, the method can include: receiving an electroactive metal S100; Comminuting the Electroactive Metal S200; Optionally Comminuting a Salt S300; optionally processing battery components S400; and optionally assembling a battery S500. The method preferably functions to process an electroactive metal used for producing cathodes for metal conversion batteries, molten salt batteries, or sodium metal halide batteries. The battery can include a housing, electrodes (e.g., cathode, anode, etc.) electrolyte (e.g., solid electrolyte, secondary electrolyte, etc.), separator, and/or any suitable materials and/or components.

### 2. Example

In an illustrative example, the method can include receiving a brittle ferrous material (e.g., iron grit, pig iron, high-carbon iron alloy such as iron with a carbon content exceeding about 0.5 wt %, etc.), comminuting the ferrous material to form iron-containing particles, and mixing the iron-containing particles with a salt and optionally additives to form a battery mixture that can be used to produce electrodes for a battery.

In a second illustrative example, the method can include receiving a ferrous alloy material comprising an alloying element that can be etched (e.g. silicon, aluminum, etc.), etching the alloying components from the ferrous alloy material (e.g. through selective alkaline leaching, chemical dealloying, selective digestion, etc.) to form iron-containing particles, and mixing the iron-containing particles with a salt and optionally additives to form a battery mixture that can be used to produce electrodes for a battery.

In a third illustrative example, the method can include receiving a ferrous alloy powder material comprising an alloying element that can be selectively etched in an operating environment of a battery (e.g. aluminum, magnesium, manganese, zinc, etc. for sodium metal chloride batteries) to generate iron-containing particles during battery operation, and mixing the ferrous alloy powder with a salt and optionally additives to form a battery mixture that can be used to produce electrodes for a battery.

### 3. Technical Advantages

Variants of the technology can confer one or more advantages over conventional technologies.

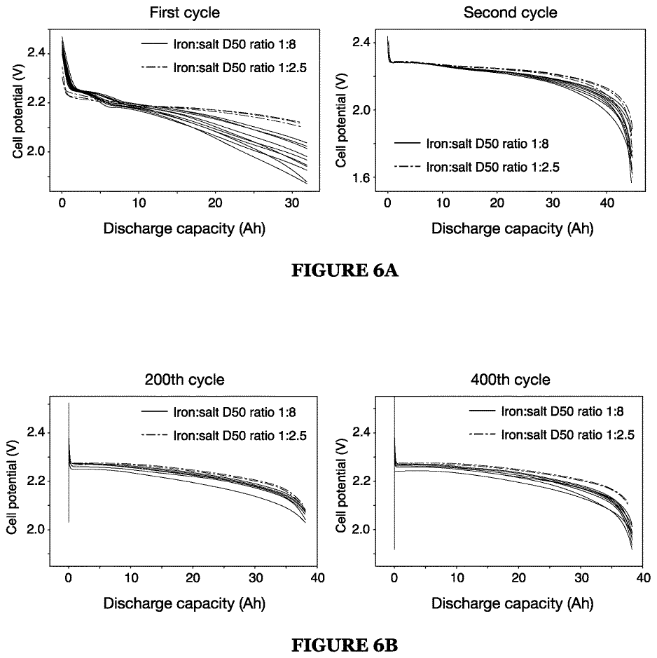

First, variants of the technology can enable milling processes (and/or other comminution processes such as crushing, atomizing, etc.) to be performed on materials that are typically malleable (and thus not able to be effectively milled). As an illustrative example, an iron material doped with at least about 0.6% carbon content can be effectively comminuted for size and/or morphology control (e.g., increased surface area). In variations of molten salt or metal conversion batteries that use such materials, the increased surface area can lead to improved electrochemical performance. The inventors have discovered that the carbon in these examples does not impair the battery performance (and may in some variations even enhance the battery performance by acting as an electrically conductive additive). Examples of such improved electrochemical performance include, but are not limited to, ≥90% accessible capacity on first charge (relative to the theoretical capacity), a decrease in normalized resistance (e.g., reduced to below about 20 Ω-(cm² solid electrolyte surface area), reduced to below about 10 Ω-(Ah of theoretical capacity), etc.), a higher charge-discharge round-trip efficiency (e.g. above about 80%), a reduction in round-trip efficiency fade (e.g., efficiency fade ≤2% per 365 cycles), a higher charge and/or discharge power capability, a reduced charge time, reduced operating temperature, and/or an improved lifetime (e.g., ≥10 year lifetime), as shown for example in FIG. 6A and FIG. 6B.

Second, variants of the technology can provide cost-effective electrode production methods using readily available materials and/or simplified processing techniques. For example, the technology can enable the use of waste, scrap, and/or lower cost iron sources (e.g., cast iron or pig iron rather than iron produced through the carbonyl process or other high purity or expensive iron processing methods) to achieve high surface area (which can facilitate increased access to the capacity of the electroactive metal) and/or improved connectivity between particles.

Third, variants of the technology can enable the use of chemical or electrochemical processes (e.g., Raney nickel process, selective leaching dealloying, etc.) to enhance the surface area of the material. As an illustrative example, an iron material alloyed with at least about 1% aluminium can be chemically or electrochemically processed to leach, etch, and/or otherwise remove the aluminium content from the alloy leaving iron particles with small sizes and/or increased surface area. In variations of molten salt or metal conversion batteries that use such materials, the increased surface area can lead to improved electrochemical performance. The inventors have discovered that the etching process can be performed during charging of molten salt or metal conversion batteries, forming aluminium containing products that do not impair the battery performance and reducing the need for additional processing steps.

Fourth, variants of the technology can facilitate better mixing of active materials and improve connectivity between particles in an active material mixture. As an illustrative example, an iron material can be annealed (e.g. heating above an austenitizing temperature, recrystallizing temperature, critical temperature, alloy dissolving temperature, etc.) to reduce the Vickers hardness to less than about 450 HV, mixed with a salt active material, compacted into pucks or pellets (e.g. under roll-compaction, uniaxial pressing, isostatic pressing, etc.), and then milled into granules with a characteristic size less than 1000 μm. In variations of molten salt or metal conversion batteries that use such materials, the reduced hardness of the iron material can enable plastic deformation (e.g. cold welding, elongation, warping, etc.) during compaction to achieve better connectivity between iron-containing particles and better contact surface area between the iron and salt particles, leading to improved electrochemical performance.

However, further advantages can be provided by the system and method disclosed herein.

### 4. Method

As shown in FIG. 1, the method can include: receiving an electroactive metal S100; comminuting the electroactive metal S200; optionally comminuting a salt S300; optionally processing battery components S400; and optionally assembling a battery S500. The method preferably functions to process an electroactive metal used for producing cathodes for metal conversion batteries, molten salt batteries, or sodium metal halide batteries. The method can be performed in batches, continuously, in response to a request, and/or with any suitable timing.

Receiving an electroactive metal S100 functions to obtain an electroactive metal that can be used to produce a battery cathode material.

The electroactive metal is preferably an alloy, which can provide a technical advantage of enabling or facilitating comminuting the electroactive metal (e.g., to increase a specific surface area of the electroactive metal).

In some variants, the electroactive metal can be a brittle alloy. The brittleness can be characterized by a hardness measurement (e.g. Vickers hardness, nanoindentation, etc.), fracture toughness testing, tensile testing, flexural testing, impact testing, elongation testing, and/or using other suitable characterization tools. In an example, the electroactive metal can have a hardness measurement between 50 and 99 on the Rockwell C scale, a Mohs hardness between 4 and 6, a Vickers hardness above 200 HV, or a Brinell hardness above 200 HB. In another example, the elongation percentage (related to the ductility) of the electroactive metal can be less than about 5% (at room temperature). For example, the electroactive metal can include elements (e.g., carbon, silicon, aluminium, etc.), which can increase the brittleness of the material, enabling or facilitating physical comminution. In variants, the electroactive metal can have a carbon content between 0.5 and 7 wt %. However, the electroactive metal can include any amount of carbon and/or other elements to enable or facilitate comminution.

In some variants, the electroactive metal can be a ferrous material (i.e., a material or iron alloy that includes relatively high iron compositions such as carbon-annealed iron, a reduced iron, cast iron, grey iron, carbon steel, white iron, cementite, scrap iron, mill scale, pig iron, iron boride, sponge iron, direct reduced iron, hot-briquetted iron, anthracite iron, ferrosilicon, ferrophosphorous, etc.). Additionally or alternatively, the electroactive metal can be nickel-based, copper-based, vanadium-based, cobalt-based, manganese-based, zinc-based, titanium-based, combinations thereof, and/or can include other suitable electroactive metals (typically but not exclusively transition metals). The electroactive metal can form an intermetallic species (e.g., alloy with, be doped with, form an intermetallic compound, etc. with one or more additional metal, semimetal, metalloid, post-transition metal, etc. elements). Exemplary elements used to form the intermetallic species (e.g., alloy) include (but are not limited to): carbon, silicon, nickel, manganese, magnesium, aluminium, boron, zinc, sulfur, phosphorous, selenium, arsenic, nitrogen, germanium, tin, lead, antimony, bismuth, tellurium, and/or combinations thereof. The intermetallic species preferably does not include metals with specific electrochemical properties or functions (e.g., metals that can react to form volatile substances, metal that can react to degrade other components of a battery, etc.). For instance, a ferrous electroactive metal for a sodium metal halide battery preferably does not include (e.g., has less than about 0.25 wt % as measured using ICP-MS) chromium, titanium, vanadium, copper and/or combinations thereof. In a specific example of a ferrous electroactive metal, an iron intermetallic species can have a carbon content of at least 0.5% by weight (e.g., 0.5%, 0.75%, 1%, 1.5%, 1.6%, 2%, 3%, 4%, 5%, etc.), which can result in preferred ductility and/or brittleness for further processing.

In some variants, an intermetallic species may facilitate or enable comminuting of the electroactive metal through chemical or electrochemical processing. Variants of the method that include chemical or electrochemical comminution can be performed using malleable electroactive metal precursors. In a specific example of a ferrous electroactive metal, an iron intermetallic species can include silicon (e.g., a ferrosilicon alloy) having a silicon content of between about 0.1 wt % and 30 wt %, which can enable selective removal of silicon via chemical or electrochemical etching (e.g. alkaline leaching, chemical dealloying, etc.) to form a higher surface area iron structure. In a specific example of a ferrous electroactive metal, an iron intermetallic species can have an aluminium content of between 1% and 50% by weight (e.g., 2%, 3%, 4%, 5%, 10%, 20%, 30%, 50%, etc.). In some variants, the presence of an alloying material in the iron intermetallic species can additionally contribute to formation of secondary electrolyte species during battery operation (e.g., during charging), which can enhance ionic transport and/or interfacial compatibility within the electrochemical cell. In some variants, the alloying material in the iron intermetallic species can additionally or alternatively react during battery operation to form an oxidized phase (e.g. a chloride phase, a fluoride phase, etc.), leaching from the intermetallic phase to form a higher surface area iron structure.

The electroactive metal can be granules, chunks, powders, sands, fragments, ingots, particulates (e.g., particles), and/or can have any other form. The electroactive metal can be porous, sponge-like, solid, or have any other density characterization. For example, in a variant, porous iron or sponge iron can contribute to higher surface areas and greater reactivity. In another variant, various processing steps can be performed to alter the material density and/or surface area.

In some variants, receiving an electroactive metal S100 can optionally include reducing the electroactive metal; carbon-annealing the electroactive metal; oxidizing (e.g., combusting) the electroactive metal, and/or cooling the electroactive metal.

Reducing the electroactive metal can be particularly beneficial for electroactive metals received as oxides and/or including significant oxygen content (e.g., ≥1 wt % oxygen) as reducing the electroactive metal can reduce the oxygen composition of the electroactive metal. Reducing the electroactive metal can be performed in a furnace, kiln, oven, and/or any other reduction apparatus (e.g., for heating the electroactive metal to at least a reducing temperature). The electroactive metal can be reduced using one or more reducing agents, where the reducing agents can optionally dope or form an intermetallic species with the reducing agent(s). Exemplary reducing agents include carbon, hydrogen, aluminium, sulfur, magnesium, and/or combinations thereof.

Carbon-annealing the electroactive metal can function to introduce carbon into and/or increase a carbon content of the electroactive metal. Carbon-annealing the electroactive metal can be performed in a furnace, kiln, oven, and/or other heating apparatus. Carbon-annealing the electroactive metal can include heating the electroactive metal and a carburizing medium to temperatures between 700 °C and 1200 °C (e.g., 700 °C, 800 °C, 850 °C, 900 °C, 950 °C, 1000 °C, 1100 °C, 1200 °C, or any value therebetween) to facilitate diffusion of the carbon into the electroactive metal. Exemplary carburizing media include (but are not limited to) charcoal, carbon powder, carburizing salts, carbon monoxide, acetylene, sodium cyanide, carbonates (e.g., barium carbonate, calcium carbonate, sodium carbonate, etc.), and/or combinations thereof.

Oxidizing (e.g., combusting) the electroactive metal can be beneficial for chemical stability and/or to alter the morphology of the electroactive metal. Variants of the method that include oxidizing the electroactive metal can be performed using malleable electroactive metal precursors. Oxidizing the electroactive metal preferably includes reacting the electroactive metal with an oxidizing agent (e.g., oxygen, ozone, water, nitric acid, hydrogen peroxide, sodium dichromate, potassium permanganate, etc.). In variants where the electroactive metal is iron, oxidizing the iron can produce iron oxides (e.g., Fₑ2O₃, Fe₃O₄, Fe₄O₅, Fe₅O₆, Fe₂₅O₃₂, Fe₁₃O₁₉, etc.), oxyhydroxides and/or hydroxides (e.g., Fe(O)OH, Fe(OH)₃, Fe(OH)₂, etc.), and/or their hydrates (e.g., FeOOH*0.4H₂O). Oxidizing the electroactive metal can be performed, for example, in a thermal reactor. Oxidizing the electroactive metal can include heating the metal to temperatures between 400 °C and 1200 °C (e.g., 400 °C, 500 °C, 600 °C, 700 °C, 800 °C, 900 °C, 1000 °C, 1100 °C, 1200 °C., and/or any value therebetween). Oxidizing the metal can result in a change of morphology. In a first example, after combustion at temperatures between 500 °C and 600 °C, a metal can transform to have more porosity or hollowness (e.g., more pores, larger pores, lower density, higher surface area, etc.). In a second example, combustion (e.g., rapid heating of the electroactive metal, etc.) can result in the electroactive metal “popping” and forming a spheroidal geometry. In variations of the second example where the electroactive metal pops, the spheroidal geometry can result in trapped internal areas with high surface area (e.g., hollow particles with complex surface geometries within the spheroidal particle). Without being bound by theory, rapid heating may promote internal pressurization (e.g., from trapped gases, phase transitions, and/or volatilization of species within the particle), thereby facilitating fracture and outward expansion of the electroactive metal. In a third example, combustion can result in an increase in size of electroactive metal particulates.

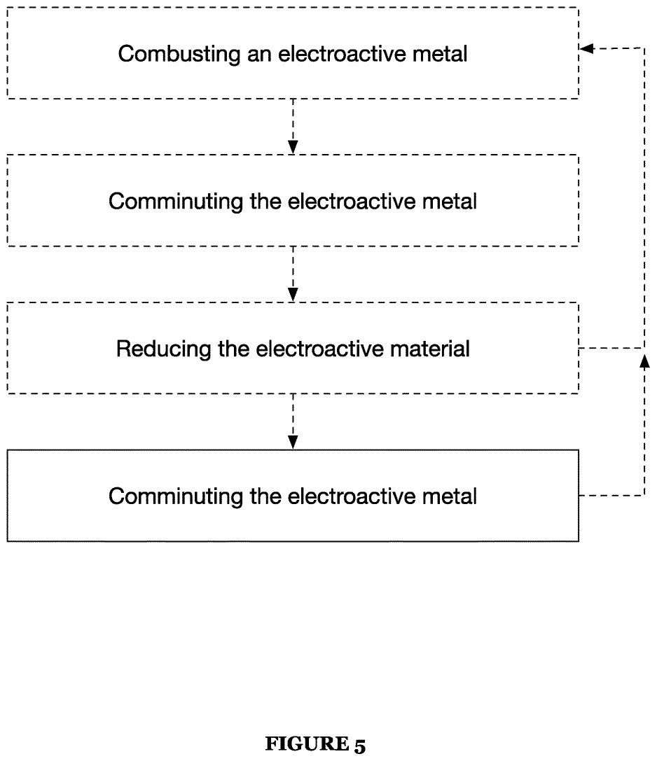

Oxidation of the electroactive metal is typically (but not necessarily) followed by reduction of the electroactive metal. Reduction of the electroactive metal can function to remove the oxygen content from the oxidized electroactive metal (i.e., return the oxidized electroactive metal to its elemental form). Reduction is preferably performed in the presence of a reducing agent (e.g., carbon, hydrogen, magnesium, aluminium, etc.). In some variants, the reducing agent can further act to dope the electroactive metal (e.g., to increase a brittleness of the electroactive metal). Oxidation and reduction of the electroactive metal can be repeated as a thermochemical cycle to further alter the morphology of the electroactive metal, example shown in FIG. 5. In one illustrative example, sponge iron particulates can be combusted and reduced a plurality of times, to increase a porosity and/or surface area of the resulting iron particles (e.g., by first popping the sponge iron and subsequently shattering the formed particles to expose a high surface area interior). The thermochemical cycle can be repeated any number of times (e.g., 1 time, 2 times, 3 times, 4 times, 5 times, 10 times, 20 times, etc.). In one variation of this illustrative example, performing the thermochemical cycle once can result in an average particle size (e.g., Feret size) between 20 and 25 microns. Performing the thermochemical cycle 3 more times (a total of 4 repetitions) on the iron particles from the preceding variation can result in an average particle size of approximately 250 microns and an increased specific surface area relative to the starting material. For example, performing the thermochemical cycle can result in an increase in surface area of between 1.1× to 10× relative to a starting surface area. The iron particles can have a resultant surface area between 0.2 and 1.6 m²/g. Repetition of the thermochemical cycle can result in the breakage, disintegration, fragmentation, and/or can otherwise expose an interior of the particulates. In variants, the combustion and reduction steps of the thermochemical cycle can be separated by other processing steps (e.g. chemical processing, cooling, comminution, etc.). In some variants, a plurality of temperature ranges can be used for the combustion and/or reduction reactions (e.g., to facilitate specific phase transformations throughout the process such as between magnetite and/or hematite, Wüstite, and iron). In some variants, an iron oxide (e.g., Fe₂O₃, Fe₃O₄, Fe₄O₅, Fe₅O₆, Fe₂₅O₃₂, Fe₁₃O₁₉, etc. ; iron oxyhydroxides and/or hydroxides such as Fe(O)OH, Fe(OH)₃, Fe(OH)₂, etc. ; hydrates thereof such as FeOOH*0.4H₂O; combinations thereof; etc.) or other iron compound (such as iron silicide, iron boride, iron nitride, iron chloride, etc.) can be reduced (and optionally cycled thereafter via further combustion and reduction cycles).

After the oxidation-reduction cycles, the resulting electroactive metal is preferably greater than about 90% (e.g., by mass, by stoichiometry, etc.) electroactive metal. Alternatively phrased, the resulting electroactive metal is preferably substantially fully reduced. However, in some variants, the resulting electroactive metal can have a composition that is 50% (e.g., by mass, by stoichiometry, etc.) electroactive metal. As one illustrative example, a resulting iron material can be at least 90% Fe by mass and at most 10% iron oxide (e.g., Fe₃O₄, Fe₂O₃, FeO, etc.). As another illustrative example, a resulting iron material can have an iron to iron oxide ratio greater than about 7. However, other suitable materials can be formed.

In some variants, particles produced using the combustion-reduction cycles may not require further comminution (e.g., can be used for an electrochemical cell without performing S200). However, S200 can be performed on the particles (or intermediate particles formed therein such as oxidized electroactive metal particles) to tune particle morphology and/or size distributions.

Cooling the electroactive metal can function to quench and/or otherwise modify a crystallinity of or structure of the electroactive metal. Cooling the electroactive metal can be performed by cryogenic chambers, liquid nitrogen, liquid helium, quenching solutions, thermoelectric cooling, water cooling systems, and/or any other cooling methods. In a first example, the electroactive metal can be quenched after heating to form a more brittle microstructure. As an illustrative example, a ferrous precursor can be quenched to form a martensite microstructure (which can result in an increased brittleness of the ferrous material).

Comminuting the electroactive metal S200 functions to change the morphology of the electroactive metal (e.g., decrease particle size, increase surface area, etc.). S200 can include grinding, milling, pulverizing, crushing, atomizing (e.g., water atomization, liquid atomization, gas atomization, etc.) and/or any other process (e.g., that can transform the electroactive metal into small particulates).

The electroactive metal is preferably comminuted in a media mill (e.g., rotary drum mill, ball mill, rotary ball mill, planetary ball mill, stirred medium mill, rod mill, tube mill, semi-autogenous mill, vibratory mill, etc.), by crushing, or in a jet mill. However, other suitable comminution systems can be used. The grinding media used in media mills can be made of alumina oxide, zirconia, steel, and/or other suitable material(s) (e.g., with hardness that exceeds that of the electroactive metal). In some variants, the grinding media can be selected to dope the electroactive metal. The ratio of grinding media to electroactive metal by weight or volume is preferably between 1:1 and 50:1 (e.g., 1:1, 2:1, 3:1, 5:1, 10:1, 20:1, 25:1, 30:1, 40:1, 50:1, a value or range therebetween, etc.). However, other ratios of grinding media to electroactive metal could be used.

The mills or crushers can have chambers made of carbon steel, stainless steel, alloy steel, high-carbon steel, cast iron, or any suitable material (e.g., with hardness that exceeds that of the electroactive metal). In some variants, the chamber material can further result in doping of the electroactive metal.

The grinding media and electroactive metal can fill the mill chamber between 5%-70% by volume or any range or value therebetween (e.g. 5%, 10%, 20%, 25%, 30%, 35%, 40%, 45%, 50%, 55%, 60%, 65%, etc.). The contents of the mill can alternatively fill any fraction of the chamber volume.

The mills are preferably operated at a revolution per minute (RPM) between 200 and 2500 (e.g., 200, 300, 350, 400, 450, 500, 550, 600, 650, 700, 750, 800, 850, 900, 1000, 1200, 1400, 1600, 1800, 2000, 2500, values or ranges therebetween, etc.).

The comminution time (where comminution time refers to time actively spent comminuting) can be between 0.5-100 hours or any range or value therebetween (e.g., 1 hour, 10 hours, 25 hours, 50 hours). The comminution time can alternatively be less than 0.5 hours or greater than 100 hours. In one specific example, a comminution time between 12-60 hours was found to modify a particle size distribution of the electroactive metal to a target particle size distribution.

S200 can be performed periodically or intermittently. For example, cycles of milling and rest can be performed iteratively (e.g., to maintain a milling temperature below a threshold temperature such as below an annealing or sintering temperature). In a variant, the electroactive metal can be milled for 10 hours, halted for 20 minutes, then repeated until the duration of the comminution time is achieved.

In other variants, small particles of the electroactive metal can be produced through atomization. Atomization can include melting the electroactive metal into a molten state in a furnace, pouring the molten metal through a nozzle or orifice to form a stream, and/or using high-pressure fluid jets to break the stream into fine droplets that rapidly cool, forming small particles. The fluid jets can utilize water, oil, alcohol, brine, liquid salts, inert gases (e.g., nitrogen, argon, helium, etc.), or any suitable substance, to break the molten metal stream for producing particles.

Other variants of the method can include crushing the electroactive metal to reduce the particles size. This can include applying high pressures to the electroactive metal. Crushing can be performed using hydraulic presses, jaw crushers, roll crushers, and or any suitable equipment. Crushing the electroactive metal can include applying forces between 0.1 tons and 200 tons (e.g. 0.1 tons, 0.2 tons, 0.3 tons, 0.4 tons, 0.5 tons, 0.6 tons, 0.7 tons, 0.8 tons, 1 ton, 2 tons, 3 tons, 4 tons, 5 tons, 6 tons, 7 tons, 8 tons, 9 tons, 10 tons, 15 tons, 20 tons, 30 ton, 40 tons, 50 tons, 100 tons, 200 tons, or any value therebetween). However, any suitable amount of force can be used to reduce the particle size of the electroactive metal. The force can be applied for any amount of time. For example, a force can be applied for any duration of time between 0.001 seconds to 1000 seconds. The force can be continuous and constant or can be repetitive. For example. in a variant, a hydraulic press may be used to repeatedly apply 10 tons to the electroactive metal until the metal is substantially crushed. In another variant, a force of 20 tons may be slowly applied to the electroactive metal and maintained for 100 seconds. However, crushing the electroactive metal can be otherwise performed.

Comminuting the electroactive metal can include performing a single processing technique or a combination of any number of processing techniques. For example, a variant of the method can include comminuting the electroactive metal by milling the electroactive metal then subsequently crushing the electroactive metal to further reduce the particle size. In another variant, the electroactive metal can be comminuted through water atomization and subsequently crushed to further reduce the size. In other variants, the method can involve milling the electroactive metal then subsequently combusting and reducing the particles. However, comminuting the electroactive metal can include any combination of techniques.

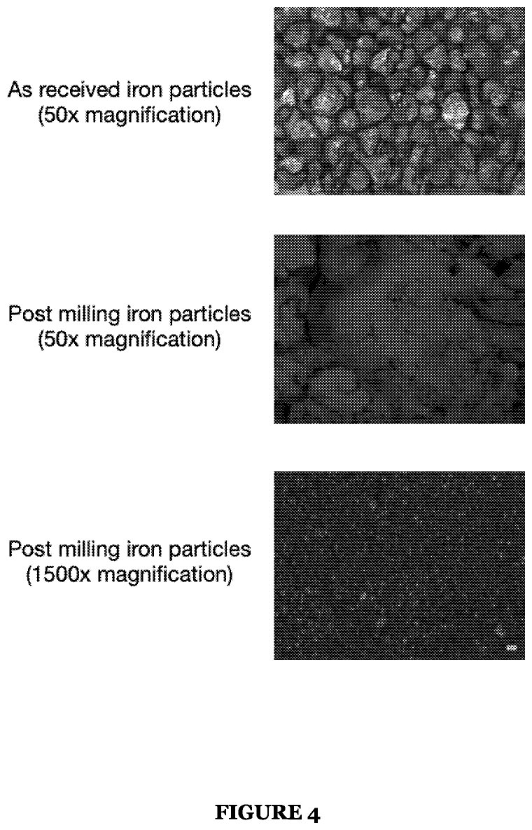

The electroactive metal particles formed by S200 preferably have an average diameter (e.g., D50 size) or other characteristic size of less than 90 microns (e.g. 90 microns, 80 microns, 70 microns, 60 microns, 50 microns, 45 microns, 42 microns, 40 microns, 35 microns, 30 microns, 25 microns, 20 microns, 15 microns, 10 microns, 8 microns, 5 microns, 3 microns, 2 microns, 1 micron, 0.5 micron, 100 nm, or any value therebetween). In a specific example (as shown for instance in FIG. 4), particles with D50 sizes between 8 and 42 microns can be achieved by milling a brittle ferrous precursor (e.g., at least at 650 RPM for 60 hours). Relatedly, the comminuted electroactive metal particles (formed in S200) preferably have a D90 value of approximately 75 microns or less (e.g., 80 microns, 75 microns, 70 microns, 65 microns, 60 microns, 55 microns, 50 microns, 45 microns, 40 microns, 30 microns, 20 microns, 10 microns, 5 microns, 1 micron, values or ranges therebetween, etc.). However, additionally or alternatively, S200 can include sieving, sedimentation, filtering, and/or other processing (e.g., to remove larger and/or smaller particles). In an example, a 45-micron sieve can be used to remove particles larger than about 45 microns.

The comminuted electroactive metal preferably has a specific surface area (e.g., BET surface area) above 0.1 m²/g (e.g., 0.1 m²/g, 0.2 m²/g, 0.3 m²/g, 0.4 m²/g, 0.5 m²/g, 0.6 m²/g, 0.7 m²/g, 0.8 m²/g, 0.9 m²/g, 1 m²/g, 1.1 m²/g, 1.2 m²/g, 1.3 m²/g, 1.4 m²/g, 1.5 m²/g, 1.6 m²/g, 1.7 m²/g, 1.8 m²/g, 1.9 m²/g, 2 m²/g or any value therebetween). The comminuted electroactive metal could alternatively have a surface area less than 0.1 m²/g or greater than 2 m²/g (e.g., when mixed with another source of electroactive metal with larger or smaller surface area to achieve an average specific surface area). In one specific example, ferrous particles with surface areas between 0.190 m²/g and 0.481 m²/g were observed after comminuting a brittle iron precursor for 60 hours at 650 RPM.

The particle morphology of the comminuted electroactive metal can be spherical, faceted, dendritic, reticular, and/or have other geometry. Exemplary particle shapes include fragments, rods, flakes, polyhedrons, spheroids, and/or other morphology.

In some variants, S200 can be performed in an inert environment (e.g., to prevent oxidation and/or other chemical reactions). In a first variant, the mill can be in a sealed chamber (e.g., glove box) that has been purged with inert gas (e.g., argon, nitrogen, etc.) prior to milling. In a second variant, the electroactive metal can be milled in a milling chamber that has been purged with inert gas. In a third variant, inert gas can be used for compressed air and/or gas milling techniques like jet milling, turbo milling, and/or any other milling techniques.

In some variants, S200 can be performed in a reducing environment (e.g., to remove oxygen and/or oxide content). For instance, an electroactive metal can be milled in a chamber with a reducing agent or reducing atmosphere (e.g., H₂, carbon, carbon monoxide, etc.).

In some variants, S200 can include cooling the comminution system. Cooling the milling system can function to hinder or prevent the electroactive metal from melting, sintering, annealing, tempering, and/or any other thermal processes. Cooling the milling system can additionally or alternatively increase a brittleness of the electroactive metal to be comminuted. The milling system can use air-cooling, water cooling, cooling jackets, and/or any other cooling methods to reduce the temperature. In a first example, the mill can be maintained at temperatures below 200 °C to prevent the electroactive metal from tempering. In a second example, cooling the comminuting system can include cooling the comminuting system to temperatures below the ductile-to-brittle transition temperature of the electroactive metal, which can function to maintain or confer brittleness of the electroactive metal (thereby enabling the use of milling to decrease particle size and/or increase surface area).

In some variants, the electroactive metal particle size and/or geometry can be further altered and/or modified inside a battery compartment (e.g., after S300, after S400, during or after S500, etc.). For example, an iron aluminium or iron zinc alloy can be added to a cathode in a sodium metal halide battery. During charging, the aluminium can form MAlX₄ (where M is an alkali metal and X is a halogen); the zinc can form ZnX₂, MZnX₃, M₂ZnX₄, or M₃ZnX₅; and/or other haloaluminate or zinc halide salts can form. Typically, these salts will be molten at operating temperatures of the electrochemical cell and thus the aluminium or zinc content of the iron alloy particles will leach, etch, and/or otherwise be removed from the alloy leaving iron particles with small sizes and/or increased surface area (e.g., etching in situ, etc.). In another example, iron alloyed with magnesium or manganese can be added to a cathode in a sodium metal halide battery. During charging, the magnesium or manganese can form MgX₂ or MnX₂. Typically, these salts will be solid at operating temperatures of the electrochemical cell and thus the magnesium or manganese content of the iron alloy particles will segregate and/or otherwise be removed from the alloy leaving iron particles with small sizes and/or increased surface area (e.g., etching in situ, etc.).

In variants, a reduced particle size or high surface area morphology of the electroactive metal can additionally or alternatively be achieved using other processes. Examples of other processes can include etching, dealloying, selective chemical dissolution, thermochemical cycling, plasma treatment, oxidation-induced “popping” to create porosity (as discussed above), freeze-thaw cycling, atomization, and/or other surface or structural modification treatments. For instance, controlled oxidation of the electroactive metal can induce internal stresses that lead to microcracking, hollowing, and/or expansion of the particles, thereby increasing surface area and forming high-porosity structures. Other treatments can include laser ablation, ultrasonic-assisted fragmentation, or exposure to reactive gases to selectively remove material from the particle (e.g., an exposed surface thereof), which can further tune particle morphology, surface roughness, and/or reactivity (e.g., by exposing specific crystal planes). One or more of these processes can be performed additionally with and/or alternatively to physical comminution to achieve a target particle size distribution, specific surface area, or desired morphology suitable for cathode fabrication.

In a specific variant, the electroactive metal can be chemically reacted (e.g., etched, dealloyed, etc.) to increase surface area and/or decrease particle size. For example, the electroactive metal can contain an alloying material (e.g., secondary material) that can be selectively dissolved, etched, and/or dealloyed from the electroactive metal. Examples such alloying materials can include silicon, magnesium, manganese, zinc, carbon, aluminium, and/or any other suitable material. For example, the electroactive metal can contain between 0.1 and 70 wt % alloying material. The alloying material can be completely or partially etched away. For example, a predetermined amount of an alloying material can be intentionally retained in the electroactive metal after etching. As a first specific example, silicon can be etched away from a silicon iron (ferrosilicon) alloy (e.g., using a caustic solution such as potassium hydroxide, ethylene diamine and pyrocatechol, tetramethylammonium hydroxide, etc.). As a second specific example, iron-aluminium alloy particles can be processed using the Raney nickel process (e.g., be reacted with an alkaline solution such as concentrated NaOH), where much or all of the aluminium can be etched away leaving iron particles with large surface areas and/or small particle sizes. However, other suitable elements can be etched in other suitable manners (e.g., plasma etching, dry etching, wet etching, etc.).

However, comminuting the electroactive metal S200 may be otherwise performed.

In variants, the electroactive metal can be further processed after achieving a predetermined particle size, morphology, and/or surface area. For example, the method can include performing heat treatments (e.g., annealing, etc.), chemical treatments, selective etching (e.g., removal of silicon from silicon-containing alloys), decarburization (e.g., removal or reduction of carbon content), surface passivation, and/or other post-processing steps. In some variants, chemical treatments can selectively remove alloying elements such as silicon, aluminium, or carbon to modify the composition, increase porosity, and/or expose higher surface area structures. For instance, silicon can be removed from an iron-silicon alloy via caustic or alkaline etching, while carbon content can be reduced through controlled oxidation or decarburization processes at elevated temperatures.

Annealing (e.g. heating above an austenitizing temperature, recrystallizing temperature, critical temperature, alloy dissolving temperature, etc.) of the electroactive metal can function to modify the microstructure, relieve internal stresses, and/or tune mechanical properties of the material. In particular, annealing can reduce dislocation density and promote grain growth, thereby increasing ductility and malleability and reducing brittleness of the electroactive metal. In the case of ferrous materials, annealing can transform harder phases (e.g., martensite or strained microstructures formed during comminution) into softer phases (e.g., ferrite, pearlite, etc.), resulting in a more malleable material. The hardness can be characterized by a hardness measurement, such as Vickers hardness, micro-Vickers hardness, nanoindentation, Brinell hardness, Rockwell hardness, etc. The inventors have found that reducing the Vickers hardness of a powder to below about 450 HV (e.g. below about 10 HV, 50 HV, 75 HV, 100 HV, 150 HV, 200 HV, 250 HV, 300 HV, 350 HV, 400 HV, etc.) can be advantageous for downstream processing steps such as compaction, granulation, or electrode formation, where improved particle deformability can enhance particle packing and mechanical integrity. Annealing can be performed at temperatures between approximately 500 °C and 1500 °C (e.g., 500 °C, 600 °C, 700 °C, 800 °C, 900 °C, 1000 °C, 1100 °C, 1200 °C, 1300 °C, 1400 °C, 1500 °C, or any value and/or range therebetween). Annealing can optionally be performed in controlled atmospheres to limit oxidation or to further tailor composition. For example, annealing can be performed under inert atmospheres (e.g. nitrogen, helium, argon, etc.), in a hydrogen containing atmosphere (e.g. 1% hydrogen, 5% hydrogen, 20% hydrogen, 100% hydrogen, etc.), in a carbon monoxide containing atmosphere (e.g. 1% CO, 5% CO, 20% CO, 100% CO, etc.), in a carbothermal reduction environment (e.g. in the presence of coke, coal, carbon, etc.), in a metallothermic reduction environment (e.g. in the presence of a reducing metal such as aluminium, magnesium, etc.), etc. Annealing in a reducing environment can selectively remove embrittling elements such as carbon and silicon, enabling greater reductions in hardness. Annealing in a reducing environment can also serve to remove surface oxides from the electroactive metal that may be present in the as-received material or that may form during comminution, enhancing electrochemical performance (e.g. reducing resistance, increasing first cycle capacity, etc.).

The method can optionally include comminuting a salt S300, which functions to change the morphology of the salt (e.g., to achieve a target particle size distribution, specific surface area, etc.). The salt can include LiF, NaF, KF, RbF, CsF, LiCl, NaCl, KCl, RbCl, CsCl, NaBr, KBr, RbBr, CsBr, NaI, KI, RbI, CsI, AlCl₃, and/or any other salt. S300 can be performed by mills, grinders, and/or other suitable comminution systems. The comminution system used in S300 can be the same or different from that used in S200. Operating parameters (e.g., speed, comminuting time, milling medium, etc.) used in S300 can be the same or different from those used in S200.

Comminuting the salt can achieve a particle size (e.g., average particle size, median particle size, D50, D90, etc.) between 1 μm and 50 μm (e.g., 1 μm, 2 μm, 3 μm, 4 μm, 5 μm, 6 μm, 7 μm, 8 μm, 9 μm, 10 μm, 15 μm, 20 μm, 25 μm, 30 μm, 40 μm, 50 μm, or any value and/or range therebetween). However, the salt particles can be less than 1 μm or greater than 50 μm. The characteristic particle size of the salt particles can be the same as, smaller, or larger than a characteristic particle size of the electroactive metal particle size. In a specific variant, the inventors have found that an electroactive mixture containing salt particles that are close to the size of the electroactive metal particles can have improved electrochemical performance. Without being bound by one theory, smaller salt particles can occupy interstitial spaces between the electroactive metal particles, thereby reducing void volume, increasing packing density, improving ionic or electronic contact between adjacent particles, and/or promoting more uniform reaction of the electroactive metal during cycling. In variants, the salt can be comminuted to achieve a predetermined salt particle size to electroactive metal particle size ratio. The salt particle size to electroactive metal particle size ratio can be between 1:10 and 10:1 (e.g., 1:10, 1:9, 1:8, 1:7, 1:6, 1:5, 3:10, 2:5, 1:2, 3:5, 7:10, 4:5, 9:10, 1:1, 10:9, 5:4, 10:7, 5:3, 2:1, 5:2, 10:3, 5:1, 6:1, 7:1, 8:1, 9:1, 10:1, or any value and/or range therebetween). However, the salt can be comminuted to any suitable particle size.

In a first trial of salt milling operated at a milling speed of about 2000 rpm, a rate of 400 kg/hr, the resulting particle size distribution included a D10 of about 3-5 microns, a D50 of about 20-25 microns, a D90 of about 45-55 microns, and a D99 of about 70-100 microns. In a second trial of salt milling operated at about 2500 rpm with substantially the same throughput and anti-caking rate, the resulting particle size distribution included a D10 of about 2-4 microns, a D50 of about 12-17 microns, a D90 of about 35-40 microns, and a D99 of about 45-55 microns. In a third trial of salt milling operated at about 2800 rpm the resulting particle size distribution included a D10 of about 2-4 microns, a D50 of about 10-15 microns, a D90 of about 25-35 microns, and a D99 of about 40-50 microns. In a fourth trial of salt milling operated at about 2800 rpm, the resulting particle size distribution included a D10 of about 2-3 microns, a D50 of about 8-12 microns, a D90 of about 25-30 microns, and a D99 of about 35-45 microns. In these examples, increasing classifier speed was associated with progressively smaller particle size metrics, and finer particle distributions were maintained at increased throughput.

In a first variant, salt can be comminuted with the electroactive metal. In an example, the salt can be co-milled with the electroactive metal. In this example, the electroactive metal can act as milling media for the salt. The electroactive metal and salt can be added to the mill at the same time or at different times. In an example, the electroactive metal can be milled (e.g., for a first comminution time) before adding salt into the mill. Comminuting the salt with the electroactive metal can, in addition to or alternative to modifying a particle size distribution of the salt, result in a thoroughly mixed electroactive metal-salt mixture.

In a second variant, comminuting the salt can be done separately from comminuting the electroactive metal. Comminuting salt separately can allow for more control in the salt particle size distribution. For example, a first mill can be used to comminute the salt, and a second mill can be used to comminute the electroactive metal.

However, comminuting a salt S300 may be otherwise performed.

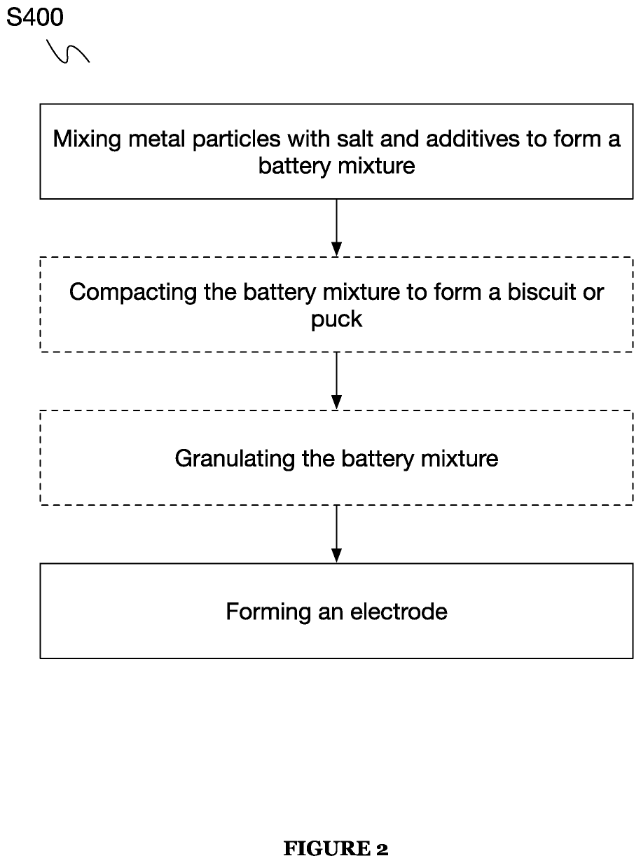

The method can optionally include processing battery components S400, which functions to form components (e.g., cathode, anode, electrodes, etc.) to be used in a battery. As shown for example in FIG. 2, S400 can include: mixing the electroactive metal with a salt and/or additives, compacting the mixture, granulating the mixture, and/or any other suitable steps.

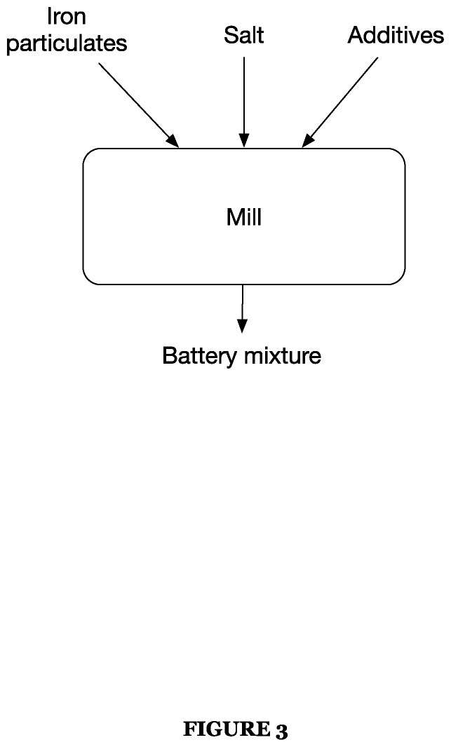

As shown for example in FIG. 3, S400 can include mixing the electroactive metal particles with salt (e.g., when S300 is not performed), electrolyte, additives, and/or other suitable material(s). Mixing the metal particles with the salt and additives can function to form a mixture used to make battery materials (e.g., in a charged or discharged state). S400 can be performed by a mill, mixer, and/or any other processing or mixing equipment.

In some variants, the mixture formed in S400 can include the electroactive metal, salt, and optional additives in varying proportions to achieve target electrochemical properties, particle packing, and conductivity. For example, the mixture can comprise approximately 35-65 wt % electroactive metal (e.g., iron or an iron intermetallic species) and 25-55 wt % salt (e.g., LiF, NaCl, or other suitable halide salts). Additives (such as binders, conductive additives, secondary electrolytes, stabilizers, etc.) can optionally be included at 0-15 wt % of the total mixture. Specific examples include a mixture containing 35 wt % iron particles, 55 wt % salt, and 10 wt % additive, or alternatively, a mixture predominantly composed of iron particles (e.g., 60-70 wt % iron) with correspondingly lower salt content (e.g., 20-30 wt % salt and 10 wt % additives).

The composition ranges are intended to be flexible and can be adjusted depending on the desired battery performance, including capacity, cycling stability, ion transport characteristics, and/or other battery performance metrics. In some implementations, the salt fraction may be increased to promote higher energy density, while in other instances, lower salt content may be used to improve electronic conductivity. Additives can be included to enhance mechanical stability, improve interfacial compatibility with the electrolyte, and/or can otherwise function.

Exemplary additives can include electrically conductive material (e.g., a metal with a standard electrode redox potential greater than that of the electroactive metal such as nickel when the electroactive metal is iron; graphene; graphite; carbon nanotubes; conductive polymers; etc.), mechanical additives (such as malleable iron, iron with a Vickers hardness below about 450 HV, ductile iron, high purity such as ≥99 wt % iron particles, etc. in variants where the electroactive metal is an iron alloy), sodium fluoride (or other alkali metal halides), aluminium, aluminium halides, sulfur-containing species (e.g. elemental sulfur, iron sulfide, nickel sulfide, etc.), and/or any other additives. In a specific example (e.g., for iron as electroactive material), malleable iron with a Vickers hardness below about 450 HV can be added to facilitate compaction of the mixture into a biscuit. In these variants, malleable iron particles can have a surface area (e.g., BET) between 0.01 and 1 m²/g. In an example, a mixture of electroactive metal (e.g., brittle iron, etc.), salt, and malleable iron can be formulated to achieve a predetermined salt to elemental iron ratio (e.g., weight, volume, stoichiometric, etc.). In some variants, a predetermined ratio of electroactive metal (e.g., brittle iron, etc.) to malleable iron can be between 10:1 and 1:10 by weight (e.g., 10:1, 9:1, 8:1, 7:1, 6:1, 5:1, 4:1, 3:1, 2:1, 1:1, 1:2, 1:3, 1:4, 1:5, 1:6, 1:7, 1:8, 1:9, 1:10, or any value and/or range therebetween). The mixture can have a composition between 0-100% of malleable iron content by mass. In specific variants, the inventors have found that a mixture with a 1:1 ratio of brittle iron and malleable iron can allow improved compaction and granule formation while optimizing cost efficiency.

S400 can include compacting the battery mixture. Compacting the battery mixture functions to form a biscuit, puck, brick, and/or any other shape that can be used for producing the battery (e.g., loading a housing with the mixture). By forming a compactified mixture, the mixture can be more easily handled than a powder mixture and may have improved electrical and/or chemical contact between components. The compacting can be performed, for example, by a hydraulic press, mechanical press, roller compactor, and/or any other press or compactification system. As an illustrative example, an applied pressure between 0.01-100 tons (or any range or value therebetween such as 0.1 tons, 1 ton, 10 tons, 50 tons) can be applied to the mixture to compactify the mixture. The applied pressure can alternatively be less than 0.01 tons or greater than 100 tons.

S400 can include chemical processing. The chemical processing can function to modify the electrochemical properties of the battery mixture. In a first variant, the battery mixture can be decarburized (e.g., to improve conductivity of the resultant battery components, to remove carbon from the materials, etc.). Other exemplary chemical treatments can include sulfurization, phosphorization, passivation, oxidation, and/or any other chemical treatments.

S400 can include granulating the battery mixture. Granulating the battery mixture can function to make the battery mixture more handleable and manageable. In a first variant, the compacted mixture can be mechanically broken apart into chunks with a D50 between 100 and 1000 microns. In a second variant, a battery mixture (e.g., as powder, compact battery mixture, etc.) can be agitated with a binder to create granules.

However, processing battery components S400 can be otherwise performed.

The method can optionally include assembling a battery S500, which functions to create a battery containing the battery mixture (e.g., from S400, salt from S300, electroactive metal from S200, etc.). For example, the battery can be a sodium metal chloride battery (e.g., ZEBRA battery), lithium-ion battery, sodium-ion battery, zinc-ion battery, lithium-sulfur battery, flow battery, solid-state battery, magnesium-ion battery, calcium-ion battery, or any other battery type.

S500 can include loading a battery case (e.g., a housing) with battery materials. The battery materials are typically loaded in a discharged state (e.g., as this state is typically easier to handle, safer, less prone to reaction upon exposure to atmosphere, etc.). However, the battery materials can be loaded in a charged state, in a mixture of states (e.g., some materials can be in a charged state and others in a discharged state), and/or the battery materials can be added in any suitable state. The battery materials can be added in a solid phase, one or more battery material can be added in a liquid phase, and/or other suitable phase (e.g., a solution, colloid, mixture, etc. of one material in a solid phase suspended in a liquid phase of another material). The battery materials are usually added to the cathode region of the battery (e.g., into an enclosed volume defined by a solid electrolyte such as beta alumina). However, the battery materials can be added into any suitable region of the battery and/or housing.

S500 can include pre-cycling the battery. Pre-cycling the battery can function to condition the electrodes, increase battery stability, and enhance the battery's performance. Cycling the battery can include charging and discharging the battery. A charge-discharge cycle can be repeated any suitable number of times. In an example, a battery can be cycled (e.g., charged and/or discharged) in a manner as described in U.S. patent application Ser. No. 18/931,406 titled ‘METHOD FOR IMPROVING PERFORMANCE OF METAL CONVERSION BATTERIES AND METAL CONVERSION BATTERIES FORMED THEREFROM’ filed 30 Oct. 2024 which is incorporated in its entirety by this.

However, assembling a battery S500 may be otherwise performed.

### 5. Battery

The battery can include a housing, electrodes (e.g., cathode, anode, etc.) electrolyte (e.g., solid electrolyte, secondary electrolyte, etc.), separator, and/or any suitable materials and/or components. The battery is preferably a metal conversion battery (e.g., sodium sulphur, lithium sulphur, sodium metal-halide, etc.). However, the battery can additionally or alternatively include other suitable battery chemistry (e.g., metal-alloy batteries such as magnesium-antimony, lead-antimony, etc.).

The electrodes can include an anode and a cathode. The electrodes can function as electrochemically active components configured to store and release energy through reactions involving one or more active materials. Each electrode typically includes an active material (e.g., a material that undergoes oxidation or reduction during cycling), an electronically conductive phase (e.g., a current collector, conductive additive, and/or conductive scaffold), and optionally a structural support (e.g., porous framework, scaffold, or container). In variants, the electrodes can include one or more current collectors (e.g., metal foils, meshes, or housings). The electrodes can be arranged in separate chambers (e.g., anode chamber and cathode chamber) that are ionically coupled via a separator and/or electrolyte while remaining electronically isolated. The electrodes can be configured to support transport of ions (e.g., alkali metal ions) to and from the electrochemically active material, facilitate electron transfer to an external circuit, and maintain physical and chemical stability under operating conditions (e.g., elevated temperatures, molten phases, and/or reactive intermediates).

The cathode (during discharge) functions to reduce a material (e.g., cathode active material) thereby providing electrons to an external load. The cathode active material is preferably stored within a cathode chamber of the battery housing, where the cathode chamber is separated from an anode chamber by a separator and/or solid electrolyte. However, the cathode active material can be otherwise disposed or arranged.

The cathode active material is preferably iron based (which can be beneficial as iron is an earth abundant material). However, the cathode active material can additionally or alternatively be based on (e.g., include, use, etc.) other metals with suitable electroreactivity (e.g., nickel, copper, manganese, vanadium, titanium, cobalt, chromium, zinc, aluminium, etc.). In variants in which the cathode active material is iron-based (e.g., iron-containing, etc.), the iron is preferably derived from a brittle ferrous material (e.g., pig iron, cast iron, high-carbon steel, grey iron, white iron, millscale, scrap iron, iron-carbon alloys, iron-silicon alloys, iron-aluminium alloys, sponge iron, reduced iron, etc.), which can facilitate comminution into particles with controlled morphology and increased surface area. In some variants, brittleness can result from the presence of alloying or intermetallic constituents (e.g., carbon, silicon, nickel, manganese, magnesium, aluminium, boron, zinc, sulfur, phosphorous, selenium, arsenic, nitrogen, germanium, tin, lead, antimony, bismuth, tellurium, and/or combinations thereof), which can reduce ductility and enable efficient milling, grinding, crushing, and/or chemical or electrochemical comminution. In specific examples, the iron-based material can include a carbon content greater than about 0.5 wt % (e.g., greater than about 1.0 wt %, 1.6 wt %, 2 wt %, 3 wt %, 4 wt %, etc.), which can reduce ductility and increase brittleness (e.g., elongation less than about 5%) thereby enabling efficient milling, grinding, or crushing processes. In some variants, the carbon can remain in the cathode active material after processing and can contribute to electronic conductivity within the battery (e.g., by forming or acting as an electrically conductive additive, conductive phase, and/or conductive network between iron particles). The use of such lower-cost and/or readily available materials (e.g., scrap iron, pig iron, mill scale, direct reduced iron, sponge iron, cast iron, scale, etc.) can reduce material cost relative to high-purity iron sources (e.g., carbonyl iron) while maintaining or improving electrochemical performance.

In some variants, the iron-based cathode active material can include one or more alloying elements and/or intermetallic components (e.g., carbon, silicon, nickel, manganese, magnesium, aluminium, boron, zinc, sulfur, phosphorous, selenium, arsenic, nitrogen, germanium, tin, lead, antimony, bismuth, tellurium, etc.). The alloying element concentration can be present in amounts to tune mechanical properties (e.g., brittleness), electrochemical properties, processability, and/or other suitable properties of the iron alloy. In a specific example, the iron alloy can include between about 0.1 wt % and 50 wt % aluminium or zinc, where the aluminium or zinc can subsequently be removed (e.g., via chemical or electrochemical etching, dealloying, in situ leaching during battery operation, etc.) to generate a higher surface area iron structure. In another example, the iron alloy can include between about 0.1 wt % and 30 wt % magnesium or manganese, where the magnesium or manganese can subsequently be removed (e.g., via chemical or electrochemical etching, dealloying, in situ leaching during battery operation, etc.) to generate a higher surface area iron structure. In another example, the iron can include carbon (e.g., residual carbon; intentionally added carbon from carburization, annealing, etc. processes; carbon from the initial iron-carbon alloy; etc.), which can optionally contribute to electronic conductivity within the cathode.

The iron-based cathode active material can be produced using one or more processing techniques. Examples of these techniques include: comminution (e.g., ball milling, rotary milling, jet milling, crushing, grinding, atomization), thermochemical processing (e.g., annealing, reduction, oxidation-reduction cycles, combustion followed by reduction, etc.), and/or chemical processing (e.g., etching, dealloying, leaching, etc.). In some variants, the iron material can be oxidized (e.g., to form iron oxides such as Fe₂O₃, Fe₃O₄, etc.) and subsequently reduced (e.g., using carbon, hydrogen, etc.) to modify morphology (e.g., increase porosity, generate hollow or fragmented structures, expose interior surfaces, etc.). In some examples, repeated oxidation-reduction cycles can be used to increase porosity and/or surface area and/or produce particles with complex internal geometries. In related variants, alloying elements (e.g., aluminium, silicon, etc.) can be selectively removed (e.g., via wet etching, alkaline treatment, electrochemical processing, etc.) to produce high surface area iron structures (e.g., analogous to Raney-type materials). In some variants, such etching can occur in situ during battery operation (e.g., during charging), thereby reducing preprocessing requirements. In some variants, the iron-based cathode active material can be annealed and/or reduced to a Vickers hardness below about 450 HV, improving connectivity after subsequent compaction and granulation process steps.

The resulting electroactive material particles (e.g., used for making the electroactive cathode mixture) preferably have a controlled particle size distribution and surface area. The particles can have a D50 particle size between about 1 micron and 100 microns (e.g., 1 micron, 2 microns, 3 microns, 4 microns, 5 microns, 6 microns, 7 microns, 8 microns, 9 microns, 10 microns, 15 microns, 20 microns, 25 microns, 30 microns, 35 microns, 40 microns, 45 microns, 50 microns, 60 microns, 70 microns, 80 microns, 90 microns, 100 microns, or any value and/or range therebetween). The particles can have a D90 between 1 micron and 100 microns. In other variants, nanoscale particles (e.g., less than 1 micron) can be used. The specific surface area (e.g., BET surface area) is preferably between about 0.05 m²/g and 2 m²/g. However, higher or lower surface areas can be achieved (e.g., depending on processing conditions and material selection, where in some variants the average surface area across all iron alloy particles is given by the above range but different subsets of the iron or iron alloy particles can be outside of the distribution, etc.). The particle morphology can include faceted, dendritic, porous, spheroidal, hollow, flake-like, and/or irregular geometries. In some variants, highly faceted particles can include particles having a plurality (e.g., 4, 6, 8, 10, 12, 20, 24, 30, 50, 60, 80, 100, values or ranges therebetween, etc.) of planar surfaces, sharp edges, corners, cleaved surfaces, angular contours, and/or crystal-like features (e.g., as produced by brittle fracture, comminution, selective etching, etc.), optionally with an aspect ratio and/or edge-to-radius ratio greater than that of rounded or spheroidal particles. In some variants, particles can exhibit multiple discernible facets (e.g., at least 5 or more planar faces observable by microscopy). In some variants, increased surface area and/or porosity can improve electrochemical performance (e.g., increased accessible capacity, reduced resistance, improved kinetics, and/or improved uniformity of reaction). However, the cathode active material can have any suitable composition, morphology, and/or method of production.

The iron particles can be mixed with additives, salt particles, and/or any other material to produce an electroactive material. In variants, the mixture can include between 20% and 80% by weight of salt, between 20% and 80% by weight of iron particles, and between 0% and 60% by weight of additives. For example, a specific variant of the mixture can include 55 wt % salt, 35 wt % iron particles, and 10wt % additives. In another specific variant, the mixture can include 75 wt % salt, 20 wt % iron particles, and 5 wt % additives. In another specific variant, the mixture can include 50 wt % salt, 50 wt % iron particles, and 0.1 wt % additives. In another specific variant, the mixture can include 30 wt % salt, 50 wt % iron particles, and 20 wt % additives. However, the electroactive mixture can have any suitable composition.

The electroactive material particles can be mixed with mechanical additives to improve electronic and ionic connectivity after subsequent compaction and granulation process steps, especially if the electroactive material is a brittle alloy. In some variants, the iron particles can be mixed with malleable iron particles with a Vickers hardness below about 450 HV in a weight ratio of brittle alloy to malleable alloy or powder between 2:8 and 8:2.

In variants, the electroactive material mixture can be in the form of pellets, granules, grains, and/or any other suitable format. In a specific example, the electroactive material mixture can be compacted into pellets and/or granules. In variants, compaction can remove voids from the particulate mixture. In variants where the electroactive material is malleable with a Vickers hardness below about 450 HV or contains malleable particles with a Vickers hardness below about 450 HV as a mechanical additive, compaction can serve to deform the malleable particles (e.g. cold-weld, warp, etc.) to form larger continuous networks of electroactive material within the pellets or granules. In variants, the electroactive material mixture can be milled and/or broken into smaller granules. The pellets and/or granules can be spherical, oblong, facetted, prismatic, and/or have any other geometry. In variants, pellets and/or granules of the electroactive mixture can have a characteristic size (e.g., average, median, D50, etc.) between 10 microns and 1000 microns (e.g., 10 μm, 20 μm, 30 μm, 40 μm, 50 μm, 60 μm, 70 μm, 80 μm, 90 μm, 100 μm, 200 μm, 300 μm, 400 μm, 500 μm, 600 μm, 700 μm, 800 μm, 900 μm, 1000 μm, or any suitable value and/or range therebetween).

The anode (during discharge) functions to oxidize a material (e.g., anode active material) thereby completing an electrical circuit to enable the energy storage device to power a load. The anode active material is preferably stored within an an0de chamber of the battery housing, where the anode chamber is separated from the cathode chamber by a separator and/or solid electrolyte. However, the anode active material can be otherwise be disposed or arranged.

The anode active material is preferably an alkali metal-based material (e.g., a material that includes one or more of lithium, sodium, potassium, rubidium, and/or cesium). As a specific example, the anode active material can include (e.g., consist of, be composed of, consist essentially of, be composed essentially of, etc.) sodium (which can be beneficial as sodium is an earth abundant material). However, other suitable anode active materials can be used (e.g., alkaline earth metals, metalloids, etc.).

Typically, the energy storage device is anode active material limited (e.g., includes excess atomic percentage of cathode active material compared to anode active material). However, the energy storage device can be cathode active material limited and/or include identical amounts of anode active material and cathode active material. For instance, in a fully discharged state, the energy storage device can include sodium chloride and iron (or mixtures of iron and other materials) and in a fully charged state, the energy storage device can include sodium (e.g., molten sodium), iron chloride, and iron (e.g., as there is excess iron relative to sodium). However, the energy storage device can include any suitable materials in any state.

Between charging and discharging, the battery storage device can include other phases of material (e.g., Na₆FeCl₈). Relatedly, during charging and/or discharging, other phases of material are preferably not formed. Undesirable phases can include phases with average iron oxidation states exceeding 2 such as FeCl₃ (and/or mixtures of FeCl₂ and FeCl₃), clusters (e.g., Fe₂Cl₄, Fe₂Cl₅, Fe₃Cl₆, etc.), and/or other phases (such as related materials including alkali metals like Na₂FeCl₄ and NaFeCl₄). In a specific example, the amount of undesirable phases present in the energy storage device is preferably less than about 5% (e.g., by mass, by stoichiometry, etc.) of the composition of active material. However, any suitable amount of undesirable phases can be included. In some variants, the presence of a small amount of the undesirable phase (e.g., ≤5%, ≤4%, ≤2.5%, ≤1%, ≤0.5%, ≤0.1%, etc. where percentage can be a mass percentage, stoichiometric percentage, etc.) can contribute to (e.g., improve a stability of) the active material (e.g., by decreasing particle degradation, by slowing or preventing Ostwald ripening, by passivating a surface, etc.). The phases can be measured using any suitable diffraction (e.g., neutron diffraction, electron diffraction, x-ray diffraction, etc.), direct imaging (e.g., scanning electron micrography, transmission electron micrography, etc.), spectroscopy (e.g., vibrational spectroscopy, electronic spectroscopy, nuclear spectroscopy, etc.), titration, and/or other suitable analytic technique (typically, but not exclusively, performed on a disassembled cell).

The electrolyte preferably functions to facilitate transport of active ions between the cathode and the anode while hindering the transport of electrons (e.g., the electrolyte preferably has a high ionic conductivity and a low electronic conductivity). In some variants, the electrolyte can additionally or alternatively function as a separator, act as an overcharge protector, extend a lifetime (cycle life, calendar life, etc.) of the energy storage device, and/or can otherwise function. The electrolyte can include solid electrolyte, liquid electrolyte (e.g., molten salt electrolyte), and/or any suitable electrolyte component(s).

The solid electrolyte is preferably β-alumina (e.g., more accurately a polyaluminate with a cation to match a mobile ion such as sodium, potassium, thallium, ammonium, hydronium, etc. such as a sodium polyaluminate with a chemical formula Na₁₊ₓAl₁₁O_{17+x/2} for 0≤x≤0.57, a doped sodium polyaluminate such as including iron doping, lithium doping, magnesium doping, etc.) solid electrolyte (BASE). The BASE can be β-alumina (e.g., β-alumina with hexagonal symmetry and a unit cell with two spinal blocks and two adjacent conduction planes), β″-alumina (e.g., β-alumina with rhombohedral symmetry and a unit cell with three spinal blocks and adjacent conduction planes), and/or other suitable β-alumina structures can be used (e.g., doped β-alumina). However, additional or alternative solid electrolytes can include: NASICON materials (e.g., sodium super ionic conductors such as Na₁₊ₓZr₂SiₓP₃₋ₓO₁₂0≤x≤3 or other related materials such as with Na, Zr, and/or Si replaced with isovalent elements; NASIGLAS; Na₄Zr₂Si₃O₁₂; etc.), sodium conducting membranes (e.g., poly(ethylene oxide) plasticized with tetraethylene glycol dimethyl ether and/or sodium triflate or other sodium salts), and/or other suitable solid electrolytes. In some variants, the solid electrolyte can include (e.g., be coated with) an additive to improve wettability to electrode material (e.g., molten sodium). For instance, carbon powder can be used to improve the wettability and/or wicking of the electrode material.

The secondary electrolyte is preferably an aluminate (e.g., tetrachloroaluminate) and/or other aluminium containing material. For example, the secondary electrolyte can include sodium aluminium chloride (e.g., NaAlCl₄, NaAl₂Cl₇, etc.), sodium aluminium bromide (NaAlBr₄), sodium aluminium iodide (NaAlI₄), sodium aluminium ethyl chloride (e.g., NaAl(C₂H₅)Cl₃), combinations thereof, and/or other suitable aluminates. However, the secondary electrolyte can additionally or alternatively include any suitable species.

The housing preferably functions to contain the cathode (e.g., cathode active material) and anode (e.g., anode active material) such as to separate or isolate the electrodes from an external environment (e.g., hinder or prevent water ingress from an environment into the interior of the battery such as to prevent formation of hydrates). The housing can additionally or alternatively function as a current collector (and/or the housing can include a current collector such as a current collector for the anode and a current collector for the cathode) and/or can otherwise function. The housing is typically made of carbon steel (e.g., mild steel, nickel-coated mild steel, etc.). However, other suitable materials can be used (e.g., aluminium, copper, etc.). Typically, a cylindrical housing assembly is used (also referred to as canular). However, other suitable shapes can be realized (e.g., prismatic, spheroidal, spherocylindrical, conical, tetrahedral, etc.). Within the housing, the anode chamber, cathode chamber, solid electrolyte, and/or other compartments and/or components are typically symmetrically arranged within the housing (e.g., rotationally symmetric such as with a 2, 3, 4, 5, 6, 7, 8, etc. fold rotation symmetry; reflectional symmetry; inversion symmetry; helical symmetry; retroreflection symmetry; etc.). However, the components can be arranged in an asymmetric manner.

During operation (e.g., to enable transport of ions, during cycling, etc.), the energy storage device is typically maintained at an elevated temperature. The elevated temperature can be a temperature greater than a melting point of an active material (e.g., anode active material), greater than a melting point of a secondary electrolyte, a temperature to promote wetting of molten material on the solid electrolyte, less than a boiling temperature of an active material and/or secondary electrolyte, less than a phase transition temperature for an active material (e.g., cathode active material, anode active material, etc. in either charged or discharged state), and/or another suitable temperature. As an illustrative example, for a battery that uses sodium (e.g., for the anode, mobile ion, etc.), the battery can be operated at a temperature greater than about 97.794 °C (e.g., 100 °C, 150 °C., 190 °C, 200 °C, 250 °C, 265 °C, 275 °C, 280 °C, 285 °C, 290 °C, 300 °C, 350 °C, 400 °C, values or ranges therebetween, etc.). In a variation of this illustrative example, a battery that includes sodium tetrachloroaluminate as a secondary electrolyte can be operated at a temperature greater than about 157 °C (e.g., 175 °C, 190 °C, 200 °C, 250 °C., 265 °C, 275 °C, 280 °C, 285 °C, 290 °C, 300 °C, 325 °C, 350 °C, 400 °C, values or ranges therebetween, etc.). In another variation of this illustrative example (or its variations), a battery that includes iron chloride (e.g., as cathode active material), the battery can be operated (e.g., during continuous operation) at a temperature less than about 350 °C (e.g., 100 °C, 150 °C, 175 °C, 190 °C, 200 °C, 250 °C, 265 °C, 275 °C, 280 °C., 285 °C, 290 °C, 300 °C, 325 °C, values or ranges therebetween, etc.) to hinder or prevent formation of undesirable phases. As used herein, temperature typically refers to an average and/or target (e.g., set) temperature where variations in temperature can occur (e.g., variations between cells, variations within a cell, etc.). The variations in temperature are typically less than about 40 °C (e.g., ±40° relative to the average temperature). However, greater variations can be accounted for.

A capacity (e.g., charge capacity after a first charging cycle) of the battery (e.g., a battery as treated according to the method below) is typically between about 5 and 2000 Ah (e.g., 5 Ah , 10 Ah , 15 Ah , 20 Ah , 25 Ah , 50 Ah , 100 Ah , 150 Ah , 200 Ah , 250 Ah , 300 Ah , 400 Ah , 500 Ah , 750 Ah , 1000 Ah , 1250 Ah , 1500 Ah , 1750 Ah , 2000 Ah , values or ranges therebetween, etc.). However, the capacity can depend on the battery chemistry, anode active material, cathode active material, amount of active material, battery size, and/or other suitable conditions. The normalized capacity (e.g., normalized for the amount of metal in the cathode) is typically between 0.01 and 0.5 Ah /(g metal) (e.g., 0.02, 0.03, 0.05, 0.07, 0.1, 0.12, 0.14, 0.15, 0.17, 0.2, 0.21, 0.22, 0.24, 0.26, 0.28, 0.3, 0.31, 0.33, 0.35, 0.37, 0.39, 0.4, 0.42, 0.44, 0.46, 0.48, 0.5, values or ranges therebetween, etc.). The normalized capacity (e.g., normalized for the surface area of metal as added in the battery) is typically between 0.01 and 0.5 mAh/(cm² of exposed metal surface area) (e.g., 0.02, 0.03, 0.035, 0.05, 0.06, 0.07, 0.1, 0.12, 0.14, 0.15, 0.16, 0.17, 0.2, 0.21, 0.22, 0.24, 0.26, 0.28, 0.3, 0.31, 0.33, 0.35, 0.37, 0.39, 0.4, 0.42, 0.44, 0.46, 0.48, 0.5, values or ranges therebetween, etc.). However, the capacity can otherwise be normalized. The use of normalized capacity (e.g., normalized for amount of iron, iron surface area, etc.) can facilitate comparison between different batteries.

A resistance (e.g., measured at 1 Ah discharge, 1.5 Ah discharge, 2 Ah discharge, 2.5 Ah discharge, 3 Ah discharge, 4 Ah discharge, 5 Ah discharge, etc. at about a 1/15A/(Ah theoretical capacity) current such as during the first discharge, second discharge, third discharge, fifth discharge, tenth discharge, twentieth discharge, fiftieth discharge, hundredth discharge, thousandth discharge, ten thousandth discharge, etc.) of the battery is typically between about 1 and 50 mΩ (e.g., 1, 2, 3, 4, 5, 6, 7, 8, 9, 10, 12, 13, 16, 17, 19, 20, 21, 22, 23, 26, 28, 30, 32, 34, 38, 39, 40, 41, 44, 45, 47, 49, etc.). A normalized resistance of the battery (e.g., normalized for surface area of metal added to the battery) is typically between about 1 and 50 kΩ-(cm² of exposed metal surface area) (e.g., 2, 3, 3.5, 5, 6, 7, 10, 12, 14, 15, 16, 17, 20, 21, 22, 24, 26, 28, 30, 31, 33, 35, 37, 39, 40, 42, 44, 46, 48, 50, values or ranges therebetween, etc.). A normalized resistance of the battery (e.g., normalized for surface area of solid electrolyte, BASE, etc. of the battery) is typically between about 1 and 20 Ω-(cm² solid electrolyte surface area) (e.g., 1, 1.2, 1.4, 1.5, 1.6, 1.7, 2, 2.1, 2.2, 2.4, 2.6, 2.8, 3, 3.1, 3.3, 3.5, 3.7, 3.9, 4, 4.2, 4.4, 4.6, 4.8, 5, 5.1, 5.3, 5.7, 5.9, 6.1, 6.6, 6.8, 7, 7.2, 7.3, 7.6, 8, 8.3, 8.5, 8.9, 9, 9.1, 9.4, 9.9, 10, 10.5, 11, 12, 14, 15, 17, 18, 20, values or ranges therebetween, etc.). A normalized resistance of the battery (e.g., normalized for the full theoretical cell capacity) is typically between about 0.1 and 10 Ω-(Ah of theoretical capacity) (e.g., 0.1, 0.2, 0.3, 0.4, 0.5, 0.6, 0.7, 0.8, 0.9, 1, 1.1, 1.2, 1.3, 1.4, 1.5, 1.6, 1.7, 1.8, 1.9, 2, 2.1, 2.3, 2.5, 2.7, 2.9, 3, 3.2, 3.4, 3.6, 3.8, 4, 4.2, 4.4, 4.6, 4.8, 5, values or ranges therebetween, etc.). However, the resistance can otherwise be normalized. The use of normalized resistance (e.g., iron surface area, solid electrolyte surface area, etc.) can facilitate comparison between different batteries. In some variants, an average resistance (e.g., averaged across different discharge rates, across different discharge cycles, across different starting state of charge, etc.) can be used. For example, the resistance can be calculated as the average of the C/16.7 DC resistance at 1.5 Ah discharge and 5 Ah discharge or 2% depth-of-discharge, after a complete full charge.

### 6. Specific Examples

Specific Example 1. A method for forming a metal conversion battery in a discharged state comprising: comminuting a brittle iron alloy into iron-containing particles with a surface area greater than 0.05 m²/g and an average particle size less than 90 μm; comminuting a salt into salt particles with a D50 particle size between 1 μm and 45 μm; mixing the iron-containing particles with the salt particles in a particulate mixture such that a resulting mixture comprises between 25% and 75% salt particles by weight; compacting the resulting mixture into pellets; comminuting the pellets into granules with an average characteristic size between 100 μm and 1000 μm; and filling a cathode compartment of a battery cell with the granules.

Specific Example 2. The method of Specific Example 1, wherein comminuting the brittle iron alloy comprises milling or crushing the brittle iron alloy.

Specific Example 3. The method of any of Specific Examples 1-2, wherein the brittle iron alloy comprises a carbon content between 0.5 and 7 wt %.

Specific Example 4. The method of any of Specific Examples 1-3, wherein the brittle iron alloy comprises a silicon or aluminum content between 0.1 wt % and 70 wt %.

Specific Example 5. The method of Specific Example 4, further comprising chemically etching away a portion of the silicon or aluminum from the brittle iron alloy.

Specific Example 6. The method of any of Specific Examples 1-5, further comprising adding a malleable iron powder to the particle mixture, wherein the malleable iron powder has an average Vickers hardness below 450 HV, such that an amount of the malleable iron powder is greater than or equal to 20% by weight of the iron-containing particles in the particulate mixture.

Specific Example 7. The method of any of Specific Examples 1-6, further comprising annealing the iron-containing particles.

Specific Example 8. The method of Specific Example 7, wherein the annealed iron-containing particles have an average Vickers hardness of less than 450 HV.

Specific Example 9. The method of any of Specific Examples 1-8, wherein the ratio of a D50 particle size of the salt particles and a D50 particle size of the iron-containing particles is between 4:1 and 1:2.

Specific Example 10. An electrochemical cell comprising: an anode compartment configured to contain alkali metal during operation; a cathode compartment comprising a particulate mixture, the particulate mixture comprising: between 25 and 100 wt % iron-containing material, wherein the iron-containing material comprises an iron alloy formed from a mixture of iron and one or more alloying elements, wherein the iron-containing material has a surface area higher than 0.05 m²/g; and between 0 and 75 wt % salt particles; a solid electrolyte disposed between the anode compartment and cathode compartment; and a secondary electrolyte interspersed between the particles in the cathode compartment, wherein the secondary electrolyte is in a liquid or molten state at an operating temperature of the cell.

Specific Example 11. The electrochemical cell of Specific Example 10, wherein the iron alloy comprises a brittle iron alloy formed from a mixture of iron and one or more embrittling elements.

Specific Example 12. The electrochemical cell of Specific Example 11, wherein the embrittling elements comprise carbon, wherein the iron-containing particles comprise a carbon content between 0.5 and 7 wt %.

Specific Example 13. The electrochemical cell of any of Specific Examples 11-12, wherein the embrittling elements comprise silicon, wherein the iron-containing particles comprise a silicon content between 0.1 wt % and 30 wt %.

Specific Example 14. The electrochemical cell of any of Specific Examples 11-13, wherein the iron-containing material additionally comprises a malleable iron alloy with an average Vickers hardness of less than 450 HV, wherein an amount of the malleable iron alloy is greater than or equal to 20% by weight of the iron-containing material.

Specific Example 15. The electrochemical cell of any of Specific Examples 10-14, wherein the iron-containing material has an average Vickers hardness of less than 450 HV and comprises an iron content between 70 and 99.9 wt %.

Specific Example 16. The electrochemical cell of any of Specific Examples 10-15, wherein, during operation of the electrochemical cell, at least a portion of the alloying elements forms an electrically conductive phase within the cathode compartment

Specific Example 17. The electrochemical cell of any of Specific Examples 10-16, wherein the alloying elements comprise at least one of aluminum, magnesium, manganese, or zinc, wherein the iron-containing material comprises an alloying element content between 0.1 wt % and 30 wt %. In variation of this specific example, during operation of the electrochemical cell, at least a portion of the alloying elements forms a chloride phase within the cathode compartment.

Specific Example 18. The electrochemical cell of Specific Example 17, wherein the alloying elements comprise at least one of aluminum, magnesium, manganese, or zinc, wherein the iron-containing material comprises an alloying element content between 0.1 wt % and 30 wt %.

Specific Example 19. The electrochemical cell of any of Specific Examples 10-18, wherein a D50 particle size of the salt particles is less than or equal to four times a D50 particle size of the iron-containing material.

Specific Example 20. The electrochemical cell of any of Specific Examples 10-19, wherein the secondary electrolyte comprises NaAlCl₄ and the solid electrolyte comprises beta alumina.

Specific Example 21. The electrochemical cell of any of Specific Examples 10-20, wherein an electrical resistance of the cell is below 20 Ω-(cm² solid electrolyte surface area) or below 10 Ω-(Ah of theoretical capacity) at 2% depth-of-discharge at an operating temperature of the cell.

Specific Example 22. An active mixture for a metal conversion battery formed by the process of: reducing a particle size of an iron alloy into iron alloy particles, wherein the iron alloy particles comprise a surface area higher than 0.05 m²/g and an average particle size less than 90 μm; and mixing the iron-containing particles with salt particles, such that a resulting mixture comprises between 25% and 75% salt particles by weight.

Specific Example 23. The active mixture of Specific Example 22, wherein the iron alloy comprises between 0.1 wt % and 70 wt % of an alloying component, wherein reducing a particle size of the iron alloy into the iron alloy particles comprises etching the iron alloy to remove the alloying component.

Specific Example 24. The active mixture of Specific Example 23, wherein the alloying component comprises at least one of aluminum, silicon, magnesium, manganese, or zinc.

Specific Example 25. The active mixture of any of Specific Examples 22-24, wherein a D50 particle size of the salt particles is less than or equal to four times a D50 particle size of the iron-containing particles.

Specific Example 26. The active mixture of any of Specific Examples 22-25, wherein the iron alloy comprises between 0.5 wt % and 30 wt % of an alloying component, wherein reducing a particle size of the iron alloy comprises milling or crushing the iron alloy.

Specific Example 27. The active mixture of any of Specific Examples 22-26, wherein the process further includes compacting the particle mixture into pellets and comminuting the pellets into granules with an average characteristic size between 100 μm and 1000 μm.

Specific Example 28. The active mixture of Specific Example 27, wherein the iron alloy particles are additionally annealed prior to the active mixture being compacted into pellets.

Specific Example 29. The active mixture of Specific Example 28, wherein the iron alloy particles have an average Vickers hardness of less than 450 HV.

Specific Example 30. The active mixture of any of Specific Examples 22-29, wherein the iron alloy particles comprise a non-spherical geometry.

Specific Example 31. The active mixture as formed by any of Specific Examples 1-9 or 22-30.

Specific Example 32. A method for forming the electrochemical cell and/or components thereof (e.g., active material) of any of Specific Examples 10-21.

Alternative embodiments implement the above methods and/or processing modules in non-transitory computer-readable media, storing computer-readable instructions that, when executed by a processing system, cause the processing system to perform the method(s) discussed herein. The instructions can be executed by computer-executable components integrated with the computer-readable medium and/or processing system. The computer-readable medium may include any suitable computer readable media such as RAMs, ROMs, flash memory, EEPROMs, optical devices (CD or DVD), hard drives, floppy drives, non-transitory computer readable media, or any suitable device. The computer-executable component can include a computing system and/or processing system (e.g., including one or more collocated or distributed, remote or local processors) connected to the non-transitory computer-readable medium, such as CPUs, GPUs, TPUS, microprocessors, and/or FPGA/ASIC. However, the instructions can alternatively or additionally be executed by any suitable dedicated hardware device.

Embodiments of the system and/or method can include every combination and permutation of the various system components and the various method processes, wherein one or more instances of the method and/or processes described herein can be performed asynchronously (e.g., sequentially), contemporaneously (e.g., concurrently, in parallel, etc.), or in any other suitable order by and/or using one or more instances of the systems, elements, and/or entities described herein. Components and/or processes of the preceding system and/or method can be used with, in addition to, in lieu of, or otherwise integrated with all or a portion of the systems and/or methods disclosed in the applications mentioned above, each of which are incorporated in their entirety by this reference.

As used herein, “substantially” or other words of approximation (e.g., “about,” “approximately,” etc.) can be within a predetermined error threshold or tolerance of a metric, component, or other reference (e.g., within 0.001%, 0.01%, 0.1%, 1%, 5%, 10%, 20%, 30% of a reference), or be otherwise interpreted.

As a person skilled in the art will recognize from the previous detailed description and from the figures and claims, modifications and changes can be made to the preferred embodiments of the invention without departing from the scope of this invention defined in the following claims.

We claim:

1. A method for forming a metal conversion battery in a discharged state comprising:
comminuting a brittle iron alloy into iron-containing particles with a
surface area greater than 0.05 m²/g and an average particle size less than 90 μm;
comminuting a salt into salt particles with a D50 particle size between 1 μm and 45 μm;
mixing the iron-containing particles with the salt particles in a particulate mixture such that a resulting mixture comprises between 25% and 75% salt particles by weight;
compacting the resulting mixture into pellets;
comminuting the pellets into granules with an average characteristic size between 100 μm and 1000 μm; and
filling a cathode compartment of a battery cell with the granules.

2. The method of claim 1, wherein comminuting the brittle iron alloy comprises milling or crushing the brittle iron alloy.

3. The method of claim 1, wherein the brittle iron alloy comprises a carbon content between 0.5 and 7 wt %.

4. The method of claim 1, wherein the brittle iron alloy comprises a silicon or aluminum content between 0.1 wt % and 70 wt %.

5. The method of claim 4, further comprising chemically etching away a portion of the silicon or aluminum from the brittle iron alloy.

6. The method of claim 1, further comprising adding a malleable iron powder to the particle mixture, wherein the malleable iron powder has an average Vickers hardness below 450 HV, wherein an amount of the malleable iron powder is greater than or equal to 20% by weight of the iron-containing particles in the particulate mixture.

7. The method of claim 1, further comprising annealing the iron-containing particles.

8. The method of claim 7, wherein the annealed iron-containing particles have an average Vickers hardness of less than 450 HV.

9. The method of claim 1, wherein the ratio of a D50 particle size of the salt particles and a D50 particle size of the iron-containing particles is between 4:1 and 1:2.

10. An electrochemical cell comprising:
an anode compartment configured to contain alkali metal during
operation;
a cathode compartment comprising a particulate mixture, the particulate mixture comprising:
between 25 and 100 wt % iron-containing material, wherein the iron-containing material comprises an iron alloy formed from a mixture of iron and an alloying element, wherein the iron-containing material has a surface area higher than 0.05 m²/g; and
between 0 and 75 wt % salt particles;
a solid electrolyte disposed between the anode compartment and cathode compartment; and
a secondary electrolyte interspersed between the particles in the cathode compartment, wherein the secondary electrolyte is in a liquid or molten state at an operating temperature of the electrochemical cell.

11. The electrochemical cell of claim 10, wherein the iron alloy comprises a brittle iron alloy formed from a mixture of iron and an embrittling element.

12. The electrochemical cell of claim 10, wherein, during operation of the electrochemical cell, at least a portion of the alloying element forms an electrically conductive phase within the cathode compartment.

13. The electrochemical cell of claim 10, wherein the alloying element comprises at least one of aluminum, magnesium, manganese, or zinc, wherein the iron-containing material comprises an alloying element content between 0.1 wt % and 30 wt %, wherein, during operation of the electrochemical cell, at least a portion of the alloying elements forms a chloride phase within the cathode compartment.

14. The electrochemical cell of claim 10, wherein an electrical resistance of the cell is below 20 Ω-(cm² solid electrolyte surface area) or below 10 Ω-(Ah of theoretical capacity) at 2% depth-of-discharge at an operating temperature of the cell.

15. An active mixture for a metal conversion battery formed by the process of:
reducing a particle size of an iron alloy into iron alloy particles, wherein
the iron alloy particles comprise a surface area higher than 0.05 m²/g and an average particle size less than 90 μm; and
mixing the iron-containing particles with salt particles, such that a resulting mixture comprises between 25% and 75% salt particles by weight.

16. The active mixture of claim 15, wherein the iron alloy comprises between 0.1 wt % and 70 wt % of an alloying component, wherein reducing a particle size of the iron alloy into the iron alloy particles comprises etching the iron alloy to remove the alloying component.

17. The active mixture of claim 16, wherein the alloying component comprises at least one of aluminum, silicon, magnesium, manganese, or zinc.

18. The active mixture of claim 15, wherein a D50 particle size of the salt particles is less than or equal to four times a D50 particle size of the iron-containing particles.

19. The active mixture of claim 15, wherein the iron alloy comprises between 0.5 wt % and 30 wt % of an alloying component, wherein reducing a particle size of the iron alloy comprises milling or crushing the iron alloy.

20. The active mixture of claim 15, wherein the process further includes compacting the particle mixture into pellets and comminuting the pellets into granules with an average characteristic size between 100 μm and 1000 μm.
